(19) United States
(12) Patent Application Publication
(10) Pub. No.: US 2026/0359165 A1
(43) Pub. Date: Nov. 12, 2026

(54) CACHE

(71) Applicant: Arm Limited, Cambridge (GB)

(72) Inventors: Edward Martin McCOMBS, JR., Austin, TX (US); Andrew David TUNE, Dronfield (GB); Sean James SALISBURY, Dendron (GB); Bijoy PAZHANIMALA, Bangalore (IN)

(73) Assignee: Arm Limited, Cambridge (GB)

(21) Appl. No.: 19/670,404

(22) Filed: May 7, 2026

(30) Foreign Application Priority Data
May 12, 2025 (GB) 2507233.1

(51) Int. Cl. G06F 11/10; G06F 12/0864

(52) U.S. Cl. CPC G06F 11/1064; G06F 11/1048; G06F 12/0864

(57) ABSTRACT

A cache comprises a data bitcell array comprising a plurality of rows of bitcells, and bitcell readout circuitry configured to read a selected row of bitcells of the data bitcell array, to obtain cached data for a way group comprising at least two ways of a selected cache set of the cache, and a way-group-shared error correcting code (ECC), shared between the at least two ways of the way group, for error-protecting the cached data for the at least two ways. ECC checking circuitry determines, based on the way-group-shared ECC and the cached data for the way group, an error syndrome value indicative of whether the way-group-shared ECC corresponds to the cached data for the way group. Output circuitry outputs, to a downstream circuit component, the cached data read from the selected row of bitcells for at least one way of the way group.

The present technique relates to the field of caches.

A data processing system may have at least one cache. A cache comprises a given number of cache entries. A given cache entry of the cache is allocatable to hold information associated with a corresponding address and is associated with tag information used to identify which address corresponds to the information held in the given cache entry. A cache lookup is performed in the cache, based on a target address of information required to be accessed, to determine whether any entry of the cache holds information for that target address. If there is a hit entry of the cache for which the tag information does correspond to the target address, the information stored in that entry is returned following the cache lookup. If the cache lookup misses in the cache, a miss response is taken. Various kinds of caches may be provided, such as a load/store data cache which caches load/store data obtained from a memory system, an instruction cache which caches executable instructions obtained from the memory system, a translation lookaside buffer (TLB) which caches address translation information obtained based on page tables stored in a memory system, a branch prediction cache which holds branch prediction information for predicting branch outcomes, or a snoop filter which caches presence information indicating which data caches subject to a coherency protocol do not hold a valid cache entry corresponding to a given address and so can be omitted from being snooped in response to a load/store request for the given address.

At least some examples of the present technique provide a cache comprising: a data bitcell array comprising a plurality of rows of bitcells; bitcell readout circuitry configured to read a selected row of bitcells of the data bitcell array, to obtain: cached data for a way group comprising at least two ways of a selected cache set of the cache, and a way-group-shared error correcting code (ECC), shared between the at least two ways of the way group, for error-protecting the cached data for the at least two ways; ECC checking circuitry configured to determine, based on the way-group-shared ECC and the cached data for the way group, an error syndrome value indicative of whether the way-group-shared ECC corresponds to the cached data for the way group; and output circuitry configured to output, to a downstream circuit component, the cached data read from the selected row of bitcells for at least one way of the way group.

At least some examples of the present technique provide a system comprising: the cache described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide computer-readable code for fabrication of a cache comprising: a data bitcell array comprising a plurality of rows of bitcells; bitcell readout circuitry configured to read a selected row of bitcells of the data bitcell array, to obtain: cached data for a way group comprising at least two ways of a selected cache set of the cache, and a way-group-shared error correcting code (ECC), shared between the at least two ways of the way group, for error-protecting the cached data for the at least two ways; ECC checking circuitry configured to determine, based on the way-group-shared ECC and the cached data for the way group, an error syndrome value indicative of whether the way-group-shared ECC corresponds to the cached data for the way group; and output circuitry configured to output, to a downstream circuit component, the cached data read from the selected row of bitcells for at least one way of the way group.

The computer-readable code may be stored on a storage medium. The storage medium may be a non-transitory storage medium.

At least some examples of the present technique provide a method comprising: reading a selected row of bitcells of a data bitcell array of a cache, to obtain: cached data for a way group comprising at least two ways of a selected cache set of a cache, and a way-group-shared error correcting code (ECC), shared between the at least two ways of the way group, for error-protecting the cached data for the at least two ways; determining, based on the way-group-shared ECC and the cached data for the way group, an error syndrome value indicative of whether the way-group-shared ECC corresponds to the cached data for the way group; and outputting, to a downstream circuit component, the cached data read from the selected row of bitcells for at least one way of the way group.

Further aspects, features and advantages of the present technique will be apparent from the following description of examples, which is to be read in conjunction with the accompanying drawings, in which:

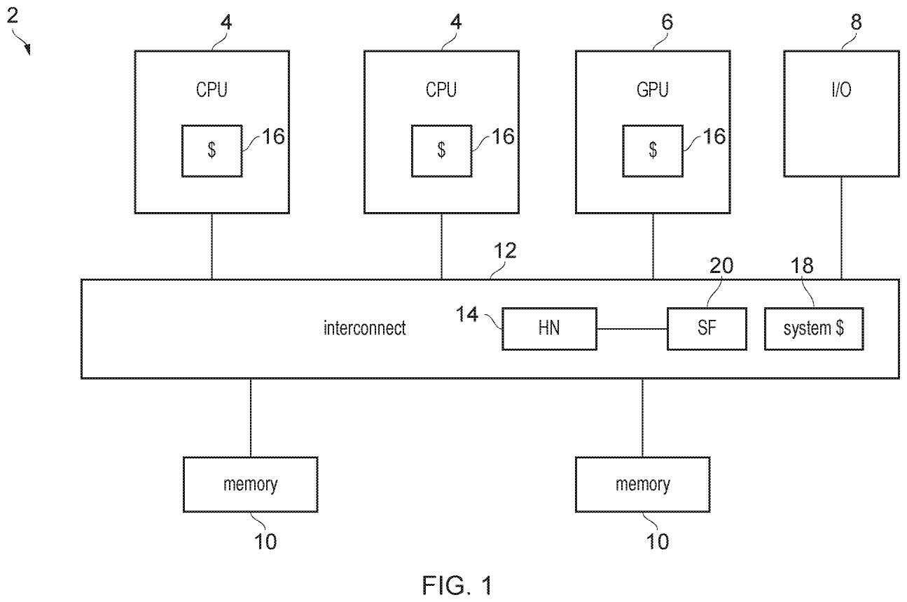

FIG. 1 shows an example of a data processing apparatus comprising at least one cache;

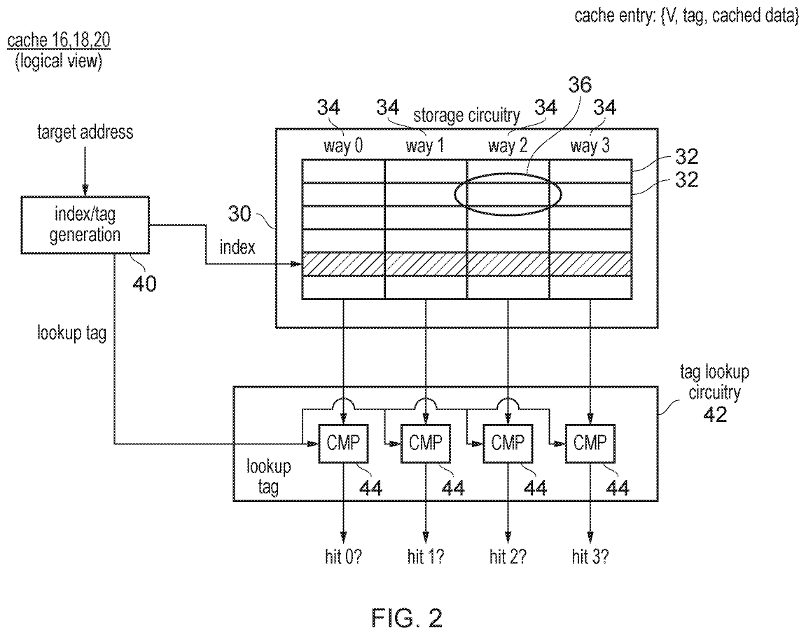

FIG. 2 illustrates a logical view of a set-associative cache;

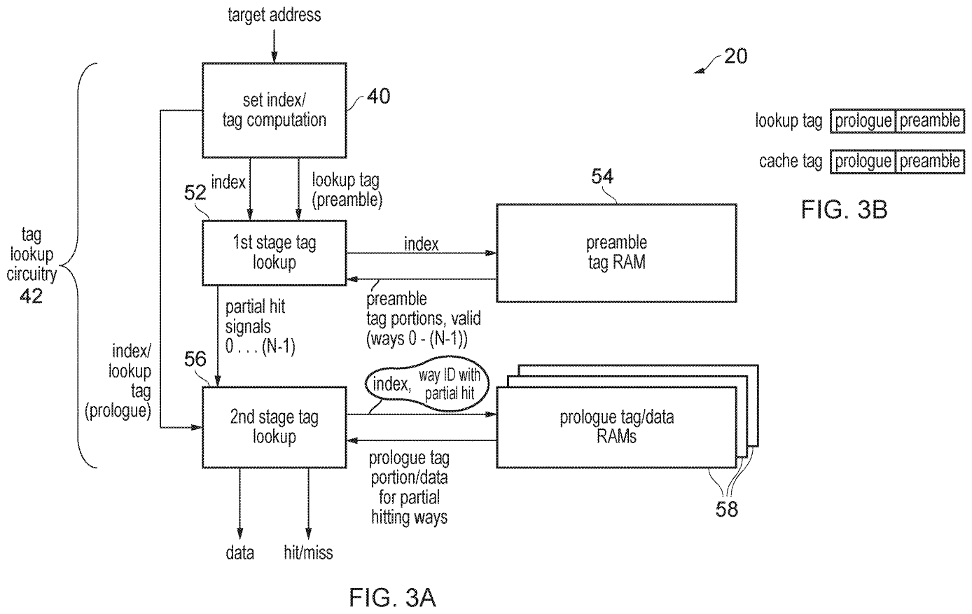

FIG. 3A illustrates a physical implementation of a cache where tag comparisons are performed in two stages where preamble tag portions are compared in a first tag comparison stage and prologue tag portions are compared in a second, subsequent, tag comparison stage;

FIG. 3B illustrates preamble and prologue tag portions;

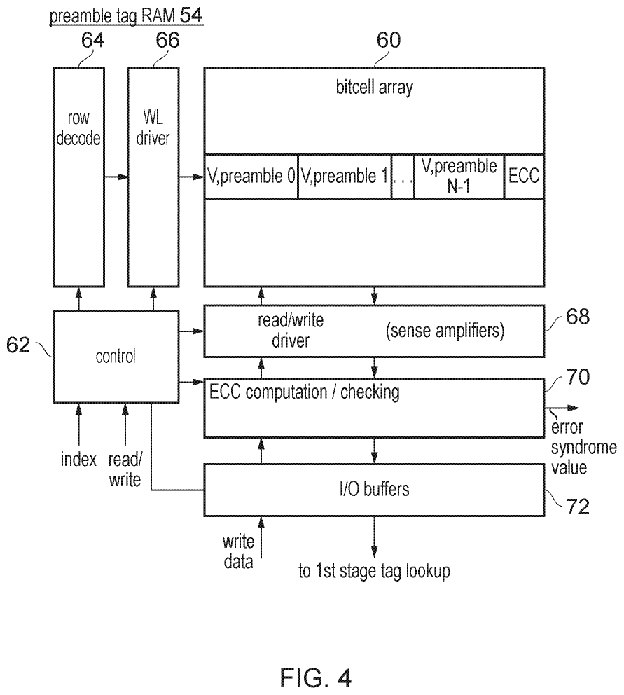

FIG. 4 illustrates an example of a preamble RAM array;

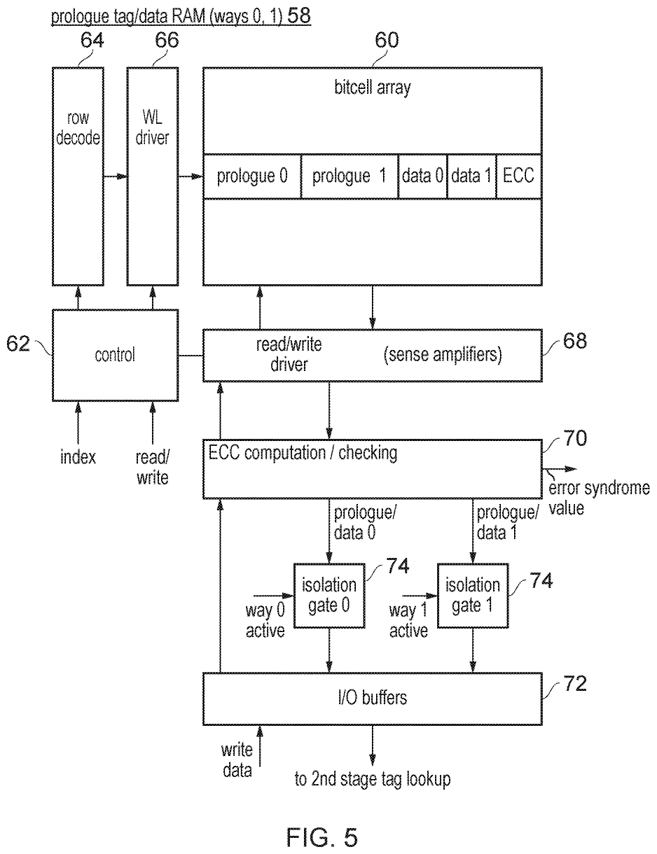

FIG. 5 illustrates an example of a prologue RAM array, in which multiple ways share a way-group-shared ECC;

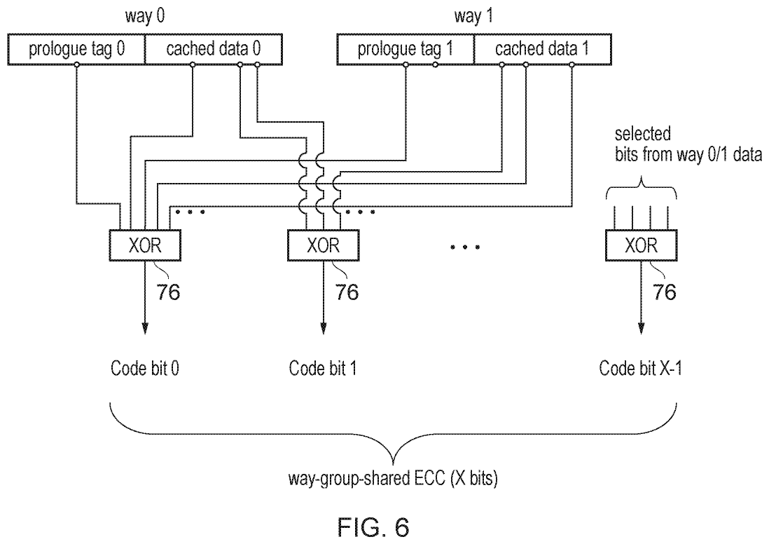

FIG. 6 illustrates an example of computation of a way-group-shared ECC;

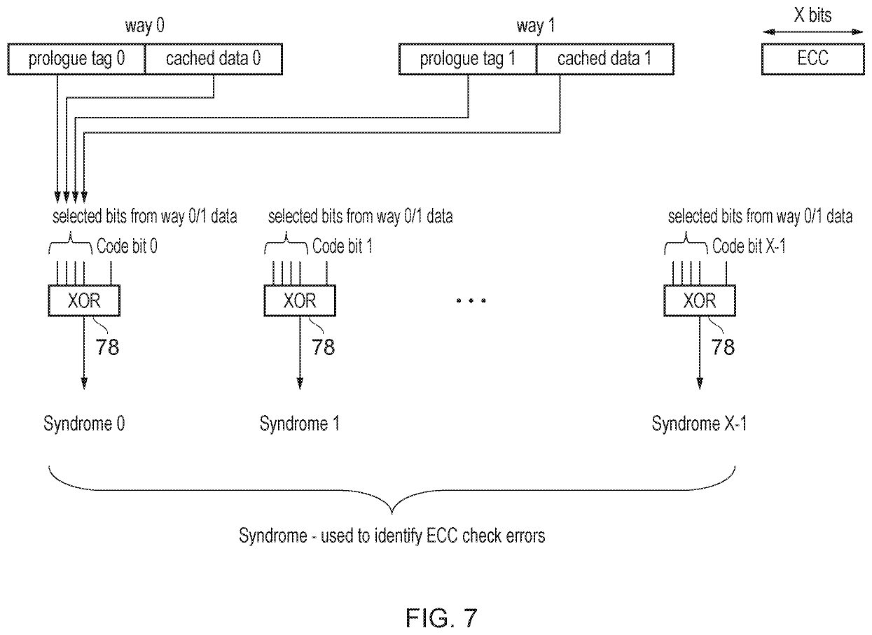

FIG. 7 illustrates an example of determining an error syndrome value based on cached data for a group of ways and the way-group-shared ECC shared between the group of ways;

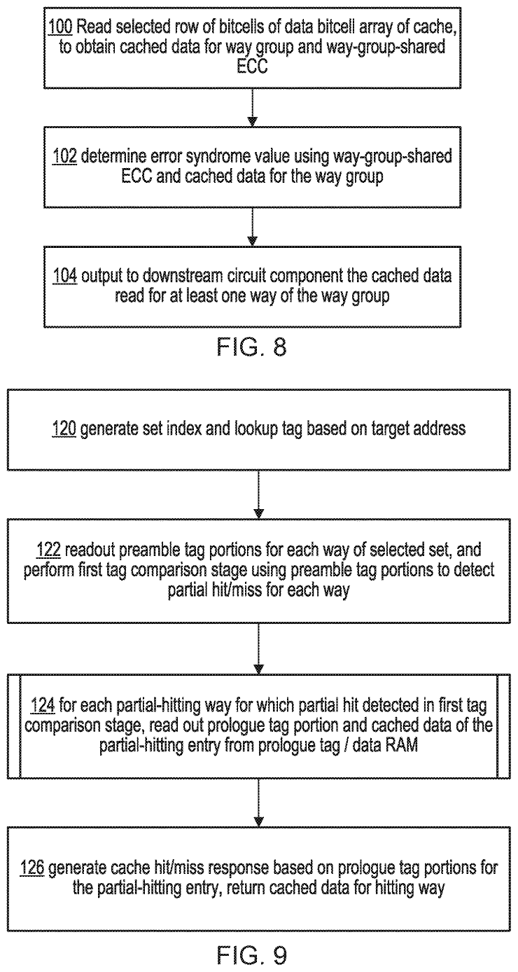

FIG. 8 illustrates a method for accessing a cache and using the way-group-shared ECC to check for errors;

FIG. 9 illustrates steps for performing a cache lookup;

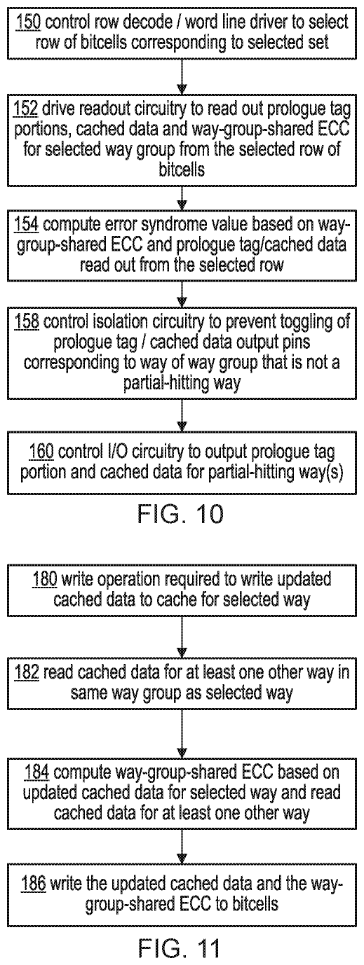

FIG. 10 illustrates steps for controlling read access to the prologue RAM array;

FIG. 11 illustrates steps for controlling write access to the prologue RAM array; and

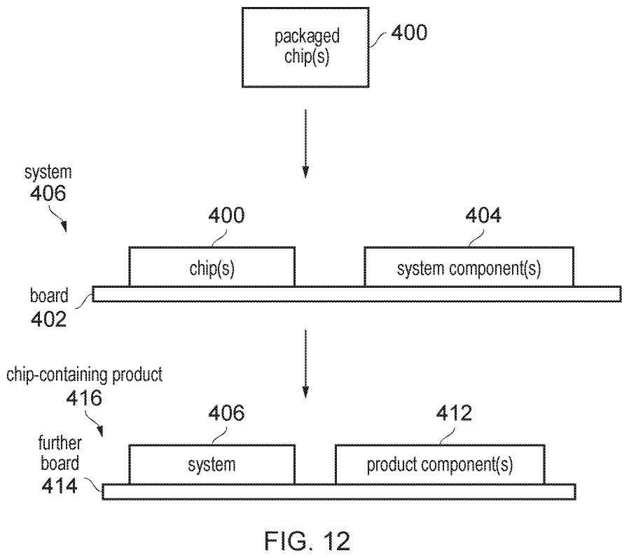

FIG. 12 illustrates a system and a chip-containing product.

A cache comprises a data bitcell array comprising a plurality of rows of bitcells. Bitcell readout circuitry is provided to read a selected row of bitcells of the data bitcell array. The bitcells may be subject to randomly occurring errors which may sometimes cause a stored bit of state to change state (flip from 0 to 1 or vice versa). For example, such errors may occur due to exposure to ionizing radiation such as particle strikes. To protect against errors in downstream circuit logic which uses the cached data output from the cache, the cache stores error correcting codes (ECCs) alongside the cached data for error-protecting the cached data. An error correcting code (ECC) for protecting a given set of bits can be computed from those bits on a write operation for writing the bits to corresponding bitcells. On reading cached data from the cache, the data read out from the bit cells and the corresponding ECC can be used to determine an error syndrome value which is indicative of whether the ECC and the read out values of the data correspond to each other. The error syndrome value can then be used to detect (and in some scenarios, correct) the error.

A cache may be implemented using a set-associative allocation policy, where the cache entries are logically organised as a plurality of cache sets, each set comprising entries for at least two ways. The cached data for a given address can be allocated to any way of a particular cache set selected for that address, and cannot be allocated to entries (ways) in other cache sets not corresponding to that address. In a typical set-associative cache using ECCs to protect against errors associated with cached data, each way of a given set has its own dedicated ECC to protect the cached data for that way. However, the inventors recognised that this approach can be expensive in terms of additional circuit area and power consumption associated with storing the ECC bits in the data bitcell array.

In the examples discussed below, an ECC is shared between at least two ways of a way group comprising at least two ways of a cache set. Hence, when the bitcell readout circuitry reads out a selected row of bit cells of the data bitcell array, the bitcell readout circuitry obtains both the cached data for a way group comprising at least two ways of a selected cache set of the cache, and a way-group-shared error correcting code (ECC), shared between the at least two ways of the way group, for error-protecting the cached data for the at least two ways. ECC checking circuitry is provided to determine, based on the way-group-shared ECC and the cached data for the way group, an error syndrome value indicative of whether the way-group-shared ECC corresponds to the cached data for the way group. Output circuitry outputs, to a downstream circuit component, the cached data read from the selected row of bitcells for at least one way of the way group (it is not essential for all ways of the way group to have their cached data output to the downstream circuit component).

This approach can be seen as counterintuitive because one might think that, as the downstream circuit component may only need the cached data for one of the at least two ways in the way group, it would be wasteful to additionally read out cached data for another way (not actually needed by the downstream circuit component) to allow the error syndrome value based on the way-group-shared ECC.

However, the inventors recognised that storage of ECC bits can consume a significant fraction of the total bitcells of the data bitcell array, if an ECC is implemented per way within a given cache set. In some implementations where the number of bits of cached data per cache entry is small, there can even be more ECC bits than there are bits of cached data itself, so ECCs add a large amount of additional circuit overhead compared to a design not supporting ECCs. Also, the inventors recognised that, while the number of ECC bits needed for a given ECC scheme to protect a set of data bits with a given data word length against errors does scale with the data word length, the number of ECC bits required scales more slowly than the data word length itself. For example, for typical ECC schemes, for each doubling of the length of the data word to be protected by the ECC, the number of code bits may only increase by 1 bit. This means that, by grouping cached data from multiple cache ways of a given cache set into way groups, with a given way group of the given cache set sharing the same way-group-shared ECC computed from the data bits of the entries of each way in the group for that given cache set, the ratio of ECC bits to data bits is reduced and so the total number of stored ECC bits required for the cache as a whole can be significantly reduced. The power savings achieved by reducing the number of bit cells needed for storing ECC bits for a given number of cache entries may be greater than the additional power cost of sometimes needing to read out data for an additional way which is used only for the error syndrome value determination but is not actually needed by downstream circuit components. Hence, by sharing ECCs between ways, this can save a significant amount of cache power consumption.

Sometimes a way-specific read operation may be needed where only cached data for a specified way of the selected cache set is needed by a downstream circuit component and the cached data for other ways in the same way group of the selected cache set is not needed. In response to a way-specific read operation requesting the cached data for a specified way of the selected cache set, the bitcell readout circuitry may read out the cached data for the way group including cached data for at least one other way for which the cached data is not required for servicing the way-specific read operation, to allow the ECC checking circuitry to determine the error syndrome value using the cached data for each of the at least two ways that share the way-group-shared ECC. Hence, even though the data for the other way(s) is not actually needed by downstream logic, it is still read out for the purpose of determining the error syndrome value, so that an ECC can be shared among ways of a given way group.

In other words, the granularity with which cached data stored in the bitcell array may be requested for access from the data bitcell array by the downstream circuit component (i.e. access requests being made at granularity of data access granules) may be more fine-grained than the granularity with which the way-group-shared ECC provided error protection for the cached data (i.e. error protection being implemented at granularity of error protection granules). The data access granule may be smaller than the error protection granule. In some examples, the data access granule may correspond to one way and the error protection granule may correspond to a way group of two or more ways. In other examples, the data access granule may correspond to a group of multiple ways and the error protection granule may correspond to a multiple of the number of number of ways in one data access granule.

In response to the way-specific read operation, the output circuitry may prevent toggling of output pins corresponding to the cached data for the at least one other way. This saves power. The inventors recognised that in a typical cache implementation, the toggling of values on output buffer pins (via which cached data is output from the output circuitry of the cache array to a downstream circuit component external to the cache array) can be a more significant source of power consumption than the power consumed by the bitcell readout circuitry in reading out cached data from bitcells to provide the read out data to the output circuitry. This is because the output circuitry may have I/O drivers sized to transmit the cached data over a greater on-chip distance to external components outside the cache array. Therefore, the additional power cost of the bitcell readout circuitry reading out unneeded cached data for the at least one other way may be insignificant in comparison to the reduction in power consumption achieved by grouping ways into way groups sharing an ECC so that the number of ECC bitcells can be reduced and by preventing toggling of output pins on the interface between the cache array and the downstream circuit component.

The cache may comprise ECC computation circuitry configured to compute the way-group-shared ECC depending on the cached data for the at least two ways. Hence, a given bit of the way-group-shared ECC may depend on at least one bit of the cached data for one of the at least two ways and also depend on at least one bit of the cached data for another of the at least two ways.

The way-group-shared ECC for a given way group may be computed in response to a write operation which provides updated cache data for at least one way in that way group. Control circuitry may be provided to control, in response to a write operation to provide updated cached data for a selected way: the bitcell readout circuitry to read out the cached data for at least one other way in a same way group as the selected way, and the ECC computation circuitry to compute the way-group-shared ECC depending on the updated cached data for the selected way and the cached data read out for the at least one other way. Hence, in some cases the write operation may require an additional read cycle to read out cached data for at least one other way in the same group as the selected way for which updated cached data is being written to the cache, so that the cached data for the at least one other way (which may not be provided in the write data for the write operation) can be combined with the updated data for the selected way to calculate an updated way-group-shared ECC for the given way group that corresponds to the cached data for the given way group that results after the write operation has been performed.

The number of ways per way group may vary depending on implementation choice. The number of ways to be grouped together in a way group sharing the same way-group-shared ECC may be selected based on a trade-off between different considerations. On the one hand, grouping a larger number of ways into the same way group may further reduce the number of ECC bits needed to protect a given number of cached data bits. On the other hand, for a larger number of ways per way group, this increases the number of unneeded cached data bits that are read out when a way-specific read operation requires the cached data for a specific way to be output to the downstream circuit component but the cached data bits for other ways in the way group, although not needed by the downstream circuit component, are still to be read out for the purpose of calculating the error syndrome value.

In some examples, this trade-off may mean that it is most efficient for the way group to comprise fewer than the total number of ways in one cache set. Hence, a given cache set may comprise a plurality of way groups, each way group corresponding to a subset of ways in the set.

In the case where a given cache set comprises multiple way groups (each with a respective way-group-shared ECC shared between at least two ways of that way group), it can be efficient to implement each way group with its own respective data bitcell array (rather than sharing the same data bitcell array between two or more way groups). The bitcell readout circuitry may have row decoder circuitry which selects an entire row of bitcells of the corresponding data bitcell array, so by having a separate data bitcell array per way group this avoids the need to read out a second way group when only a first way group needs to be accessed.

Hence, in some examples, the cache is an N-way set-associative cache, and the data bitcell array is configured to store cached data for M ways of the cache, where M<N. The cache can comprise two or more of such data bitcell arrays, each configured to store cached data for a respective group of M ways of the N-way set-associative cache. Each data bitcell array may be associated with its own instance of bitcell readout circuitry, ECC checking circuitry and/or output circuitry.

In some examples, the number of ways per way group could be more than 2, for example 4 or 8.

However, in some examples, the way group sharing the way-group-shared ECC is a group of 2 ways. With a 2-way way group, the number of “unneeded” ways for which data may be read out for error syndrome calculation purposes when that data is not needed for a downstream circuit component can be reduced to a maximum of 1 (whereas for a 4 or 8 way group, the maximum number of unneeded ways could be 3 or 7 respectively). Hence, with 2-way way groups, this may in some cases provide an improved balance in the trade-off between reducing power consumption by reduced number of ECC bitcells and increasing power consumption in reading out unneeded ways' data for ECC syndrome computation.

Each cache entry may be associated with a cache tag used in a cache lookup operation to identify which address corresponds to the cached data stored in the cache entry. The cached data may be the functional data of interest to a cached-data-requesting component that is looking up the cache to identify that functional data. In contrast, the cache tag and the stored ECC bits may be used within a cache to control the cache lookup and detect/correct errors, but may not generally be of interest to the downstream cached-data-requesting component. For example, the cached data may be the load/store data for a data cache, the instructions for an instruction cache, the address translation information for a TLB, the presence information for a snoop filter, or branch prediction information for a branch prediction cache. Hence, in some examples, the way-group-shared ECC is shared between the cached data of multiple ways within a cache set (rather than merely being shared between tags for multiple ways within a cache set). It can be particularly counter-intuitive to share an ECC between multiple ways of cached data (rather than just tags), because while tags may often be read out in parallel for multiple ways of a cache set to identify which of those ways holds data for a target address being looked up in the cache, once the hitting entry has been identified for a specific way, typically only the data for that specific way may be read out and so cached data for other ways is not needed. Therefore, a skilled person might assume that it would be wasteful of unnecessary bitcell readout power to implement an ECC scheme that would require unneeded cached data for ways other than the hitting way to be read out to enable the syndrome calculation for the ECC scheme when a way-group-shared ECC is shared between multiple ways. However, the inventor recognised that this additional power in reading out extra data bits is outweighed by the power savings arising from reducing the ratio of ECC bits to data bits which becomes possible when multiple ways share the same ECC.

In some examples, the data bitcell array is separate from a tag bitcell array configured to store at least a portion of cache tags for respective ways of the cache.

In some examples, the entire cache tag is stored in the tag bitcell array.

However, in other examples, the tag bitcell array stores preamble portions of the cache tags, and the data bitcell array also contains prologue portions of the cache tags. Hence, the bitcell readout circuitry may be configured to also read out prologue tag portions for the way group from the selected row of bitcells of the data bitcell array. This can be helpful to support a two-stage tag lookup process which can help save power by avoiding costs of readout and comparison of prologue tag bits if a cache miss can already be detected from the preamble tag portions.

Where the data bitcell array also contains prologue tag portions, the way-group-shared ECC for a given way group of a given cache set may protect both the prologue tag portions and the cached data of the at least two ways of the way group.

In an implementation using the two-stage preamble/prologue tag approach, tag lookup circuitry may be provided to perform a first tag comparison stage to perform tag comparisons between a preamble tag portion of a lookup tag computed from a target address being looked up in the cache and preamble tag portions read from a preamble tag bitcell array, separate from the data bitcell array, for a plurality of ways of the selected cache set. Dependent on detecting a partial hit in the first tag comparison stage for at least one partial-hitting way of the plurality of ways, the tag lookup circuitry performs a subsequent tag comparison stage between a prologue tag portion of the lookup tag and the prologue tag portion read from the data bitcell array for the at least one partial-hitting way. In some examples, the downstream circuit component mentioned earlier, to which the output circuitry outputs read out cached data for at least one way, could include the logic of the tag lookup circuitry for performing the subsequent tag comparison stage. The two-stage tag comparison approach can help save power because prologue lookups for ways detected as missing in the first tag comparison stage can be halted to reduce power consumption when the preamble tag bits already checked in the first tag comparison stage indicate that none of the ways of the selected cache set have a tag matching the lookup tag corresponding to the target address.

In such a two-stage tag comparison approach, when the at least one partial-hitting way is in a way group shared with at least one other way for which a miss is detected in the first tag comparison stage: the bitcell readout circuitry may read out the cached data for the at least one other way to enable the ECC checking circuitry to perform the ECC checking operation to determine the error syndrome value using the cached data for the at least one partial-hitting way and the at least one other way; and the output circuitry may prevent toggling of output pins for outputting the cached data for the at least one other way to the tag lookup circuitry. Hence, even though the first tag comparison stage may have detected a given way as missing based on the preamble tag comparison, that way's data may still be read out by the bitcell readout circuitry for the (prologue) data bitcell array if that way is in the same way group as a partial-hitting way, so that the error syndrome value for the associated way group can be calculated. The additional power consumed in reading out the data for the other way is insignificant in comparison to the power saving by reducing static and dynamic power consumption because the total number of ECC bitcells in the data bitcell array can be reduced.

In some examples, the ECC checking circuitry for calculating the error syndrome value may be integrated into the cache array comprising the data bitcell array, bitcell readout circuitry and output circuitry, so that the syndrome value computation is performed locally to the bitcell readout. This contrasts with many cache implementations where ECC bits are simply treated as cached data to be read out and output via I/O buffers to downstream error correction circuit logic external to the cache RAM array for syndrome calculation and error detection/correction.

The cache may in some examples also comprise error handling circuitry configured to trigger an error handling response in response to determining, based on the error syndrome value determined by the ECC checking circuitry, that an ECC check error has occurred. For example, the error syndrome value may be interpreted by the error handling circuitry to detect whether an ECC check error has occurred. The ECC checking circuitry may also detect, from the syndrome value, whether the error is correctable (e.g. for some implementations single bit errors may be correctable but errors affecting more than one bit might be detectable but not correctable). If the error is correctable, the ECC checking circuitry may also detect the location of the bit(s) affected by the error and the correction that should be applied to the erroneous bit(s) to correct the error (e.g. flipping an affected bit from 0 to 1 or vice versa). The error handling circuitry could also trigger an error handling response (e.g. for uncorrectable errors, that response could include treating the cache lookup as missing in the cache, and/or reporting the error).

In some examples, the error handling circuitry may also be integrated into the cache RAM array, so that the integral ECC logic within the cache RAM array performs both the calculation of the error syndrome value and the error detection/correction based on that syndrome value.

However, in other examples the error handling circuitry may be external to the cache RAM array itself, and the cache RAM array could include the syndrome calculation logic and could then output the calculated error syndrome value to external error handling circuitry for subsequent error detection/correction. Hence, it is not essential for parts of the ECC check process other than syndrome value calculation to be performed within the cache RAM array.

The techniques discussed above could be applied to a variety of types of caches, such as any of the types of caches mentioned earlier.

However, these techniques can be particularly useful to be applied to a snoop filter. For a snoop filter, the cached data may comprise snoop filter information (e.g. the presence information mentioned earlier) which is indicative of which of a plurality of requester caches should be snooped in response to an event associated with an address of a given cache line. For a snoop filter, the number of bits of stored cached data may be relatively small in comparison to other caches, so if ECCs are implemented per way, the ratio between the number of ECC bits and the number of bits of cached data may be relatively high. Also, snoop filters are typically a very busy component in a typical processing system, as they a shared component shared between multiple processors that may be looked up in response to load/store operations initiated by any of those multiple processors (rather than being looked up based on activity of a single processor alone). Hence, sharing of ECCs between ways to help reduce power consumption may have a particular benefit in a snoop filter compared to other types of caches.

Specific examples are now described with reference to the drawings.

FIG. 1 illustrates an example of a data processing system 2, such as a system on chip implemented on a single integrated circuit or a packaged collection of two or more chiplets (separate integrated circuits implementing respective portions of the system 2, which are integrated into a same semiconductor package). The system 2 includes a number of memory access requesters 4, 6, 8 which share access to a shared memory 10, accessible via a memory system interconnect 12. The access requesters can include various processors, e.g. central processing units (CPUs) 4 or graphics processing units (GPUs) 6, and input/output (I/O) devices 8. Some of the access requesters 4, 6 may have their own private data caches 16 for caching load/store data obtained from the memory system 10. The private data caches 16 of the requesters 4, 6 may be subject to a coherency protocol managed by home node circuitry 14 within the interconnect 12, to ensure data coherency where when one requester 4, 6, 8 requests access to data for a given address, the requester receives the most up to date value of data for that address, which may sometimes be dirty data which another requester has updated in its own private cache 16. The interconnect 12 may also have a shared system cache 18, shared between multiple requesters, for caching load/store data from memory 10. While not shown in FIG. 1, other types of caches could also be provided, such as TLBs (translation lookaside buffers) provided in the CPU 4 or GPU 6 for caching address translation information for controlling virtual-to-physical address translation, or branch prediction caches for caching branch prediction information derived from previously detected branch outcomes, used for predicting branch outcomes for future branch instructions.

One type of cache that may be provided in the system 2 is a snoop filter 20 used by the home node circuitry 14 of the interconnect 12 to filter snoop traffic used to implement the coherency protocol for maintaining coherency between data cached in the respective private caches 16. The home node circuitry 14 implements a given coherency protocol, which defines a set of cache coherence transaction types and response protocols associated with those transaction types. Each address may, with respect to a particular requester 4, 6, be considered to be held in that requester's private cache 16 in a particular coherency state. For example, the coherency state may specify, with respect to a given address and a given requester 4, 6, whether valid data for that address is held at the given requester's private cache 16, and if valid data is held, whether that data is clean or dirty, and/or is held in an exclusive (unique) or shared state (exclusive data being held exclusively in that requester's private cache 16, and not in other requesters' private caches 16, while shared data is capable of being held in private caches of two or more requesters simultaneously). When data is held in an exclusive state, the requester holding the data as exclusive is allowed to write to the data in the cache without first issuing coherence transactions to check with the home node 14 whether other requesters could also be holding the data. When the data is held in a shared state, any write to the shared data in a given requester's private cache would require first issuing a coherence transaction to check with the home node 14 whether there are conflicting copies in other caches 16 (e.g. that coherence transaction may typically be a request that the data in the given requester's private cache 16 is upgraded to the exclusive coherency state, which may cause the home node 14 to send snoop requests to other requesters that could be holding that data, to trigger invalidation of data from those requesters' private caches 16).

The snoop filter 20 is provided for tracking (at least partially) which data addresses have corresponding data cached at certain requester's private caches 16. The snoop filter can be used to reduce snoop traffic by allowing the home node circuitry 14 to determine when data is not cached at a particular requester. The snoop filter 20 can itself be regarded as a type of cache, since it has entries which can be allocated for corresponding addresses, and hold “cached data” for that address, but unlike the data caches 16, 18 for which the cached data is load/store data read from memory following a load operation or written to memory by a store operation performed by a given requester, the cached data in the snoop filter is snoop filter information (“presence” information) indicative of which private caches 16 may hold valid entries for the associated address. The snoop filter information in the snoop filter 20 may be updated based on detecting transitions of cache coherency state for associated cache lines in the requester caches 16. For example, in response to a request from a requester 4, 6 to allocate of a cache line for a given address into its private cache 16, the snoop filter 20 may update the snoop filter information for the given address to indicate that the cache line is now held in that private cache 16. If an access from one requester causes the home node 14 to send snoops to other requesters to request invalidation of a cache line corresponding to a given address, the home node 14 can control the snoop filter 20 to update the snoop filter information for that given address to indicate that those other requester's caches 16 no longer hold the data for the given address. The snoop filter information held in the snoop filter 20 can be imprecise, in that false positives may be possible where the snoop filter 20 indicates a given private cache 16 holds the data for a given address, but actually that private cache 16 has already silently evicted the data for the given address without informing the interconnect 12.

On receiving a request for a given address from one requester 4, 6 which may potentially require other requester's caches 16 to be snooped, the snoop filter 20 can be looked up based on the given address to identify whether there is any valid entry of the snoop filter 20 corresponding to the given address. If a hit is detected, the snoop filter information in the hit snoop filter entry is used to filter which other requester's caches 16 are sent snoops, and snoops can be suppressed for a requester's cache 16 which is indicated by the snoop filter information as not holding the cache line corresponding to the given address. If a miss is detected in the snoop filter 20, then no information is available on whether the line is present at the requesters 4, 6, which could be interpreted in different ways. For an exclusive snoop filter, on a miss in the snoop filter the home node 14 may default to broadcasting snoops to all requesters 4, 6 which could potentially hold the cache line corresponding to the given address. For an inclusive snoop filter, on a miss in the snoop filter, the home node 14 may assume that the cache line corresponding to the given address is not held in any of the requester caches 16 and so may avoid sending snoop requests to any of the requester caches 16. Either type of snoop filter (inclusive or exclusive) could be used as the snoop filter 20.

In some cases (e.g. where the snoop filter 20 is an exclusive snoop filter), the snoop filter 20 may be combined with the shared system cache 18 so that a single lookup process for querying a combined data structure returns both any cached load/store data associated with the system cache 18 and associated snoop filter information associated with the snoop filter 20 which can be used to identify any requesters 4, 6 that are known not to be holding valid cached data for the associated address (and so which do not need to be snooped when another requester accesses the same cache line).

Hence, the snoop filter 20 is an example of a cache included in a data processing system, and the techniques discussed below can be applied to the snoop filter 20 (where the “cached data” mentioned in the subsequent examples can include the snoop filter information which provides information on which private caches 16 hold a cache line for an associated address). However, it will be appreciated that the techniques discussed below can also be used for other types of caches.

FIG. 2 shows a logical view of a cache, such as the data caches 16, 18 or snoop filter 20 mentioned earlier. The cache has storage circuitry 30 which comprises a number of cache entries 36 logically arranged as a number of cache sets 32 each comprising a number of ways 34. The number of ways per set is referred to as the “associativity” of the cache. In this example, the associativity is 4, so this is a 4-way set-associative cache where each set 32 comprises four ways 34. It will be appreciated that other examples could have a different associativity.

Each cache entry 36 logically comprises at least a valid indicator V indicating whether the cache entry is valid, a cache tag used to determine which address corresponds to the cache entry 36, and cached data which represents the functional information held in the cache that is useful for components outside the cache (in contrast, the valid indicator V and cache tag may be of interest internally within the cache for purposes of cache lookup, but are not of interest to the wider system). For example, the cached data can be the snoop filter information for the snoop filter 20 as discussed above. In some examples, the valid indicator V may be separate from the cached data. However, in some examples where the cache is a snoop filter, a dedicated valid indication separate from other cached data may not be needed, as a presence vector stored as cached data which indicates whether the associated cache line is held in requester caches may also serve as information indicating whether the cache entry is valid. Hence, in some cases the valid indicator could be the cached data (presence vector) itself.

When looking up the cache to check whether the cache holds a cache entry 36 corresponding to a target address, index/tag generation circuitry 40 generates an index value and lookup tag based on the target address. In some examples, the index and lookup tag could simply be respective portions of bits extracted from the target address. In other examples, the index/tag generation circuitry 40 may generate the index value by applying an index hash function to an index portion of bits extracted from the target address, and/or generate the lookup tag by applying a tag hash function to a tag portion of bits extracted from the target address.

The index value selects which set 32 is to be accessed for the target address. Hence, each address can have its cached data assigned to any entry (way) within the selected set 32 identified by the index value, and cannot have its cached data assigned to entries in other sets 32.

Tag lookup circuitry 42 reads out the cache tags for the respective entries (ways) 34 of the selected set 32 identified by the index value, and has a set of comparators 44 for comparing the lookup tag derived from the target address with the read out cache tags for each way, to identify for each way whether the lookup tag matches the cache tag. A hit signal is generated for each way, indicating a hit for a way where the lookup tag matches a cache tag, or a miss for any way where the lookup tag does not match the cache tag. The hit signals can be used to determine (i) whether the overall lookup hits or misses, and (ii) for a hit, which way's cached data should be returned in response to the cache lookup.

While FIG. 2 shows the index/tag generation logic 40 as separate from the tag lookup circuitry 42, other examples (e.g. FIG. 3A below) may treat the set/index tag generation logic as part of the tag lookup circuitry 42.

FIG. 2 shows a logical view of a set-associative cache structure. However, the physical implementation of the cache, implemented using one or more cache RAM arrays comprising bitcells storing bits according to a particular memory storage technology such as SRAM (static random access memory), may be different to the logical view. For example, the contents of a given logical cache entry 36 could be distributed over multiple cache RAMs as explained in subsequent examples. It is also possible that different cache RAMs used to store parts of the logical cache entry may use different index functions (e.g. where the cache is a skewed-associative cache, which uses different index functions for different ways of the cache set). Hence, it will be appreciated that logical diagrams showing cache organisation at a high level do not necessarily show how the logical functionality of storing cache entries and looking up cache entries would be implemented in physical circuitry.

FIG. 3A illustrates an example of a physical implementation of a set-associative cache in which tag comparisons are split into (at least) two stages. The tag lookup circuitry 42 includes a set index/tag computation circuitry 40 which computes index and lookup tag values corresponding to a target address, in a similar way to that discussed above for FIG. 2.

The stored contents of a logical cache entry 36 are distributed across separate preamble and prologue cache RAM arrays 54, 58. As shown in FIG. 3B, the lookup tag (derived from the target address being looked up in the cache) and the stored cache tag for a given cache entry (to be compared with the lookup tag in the cache lookup) can each be considered to include a preamble tag portion and a prologue tag portion.

In the example of FIG. 3A, at least the preamble tag portion and the valid indicator for each cache entry are stored in the preamble RAM array 54, and the prologue tag portion and cached data itself is stored in the prologue RAM arrays 58. In some examples, although not illustrated in FIG. 3A, some cached data could also be stored in the preamble RAM array 54. For example, some functional information associated with a given cache entry could be useful even on a miss against that cache entry (e.g. this information could include memory resource partitioning information used to control allocation of cache capacity to different requester contexts associated with different partition identifiers). If there is a form of cached data which it is useful to return even on a miss, then that cached data could be stored in the preamble RAM array 54.

Each prologue RAM array 58 corresponds to a way group comprising two or more ways of a given cache set. Hence, one cache set 32 is distributed over multiple prologue RAM arrays 58 (e.g. in the 4-way example of FIG. 2 with 2-way groups, 2 of the ways of the given set would have their prologue tag and data stored in one prologue RAM array 58 and the other 2 ways of the given set would have their prologue tag and data stored in a second prologue RAM array 58). Other examples could have more than two prologue RAM arrays 58, depending on the ratio between the associativity of the cache and the number of ways grouped into the same way group.

The tag lookup circuitry 42 includes first stage tag lookup circuitry 52 and second stage tag lookup circuitry 56. The first stage tag lookup circuitry 52 provides the index identifying the selected set 32 to the preamble tag RAM 54, which reads out a row of bitcells of the preamble tag RAM 54 corresponding to that set 32, and returns the preamble tag portions and valid indications for each way of the selected set 32. The first stage tag lookup circuitry 52 compares the preamble tag portions for each way of the set with the preamble portion of the lookup tag, and generates partial hit signals for each way. The partial hit signal for a given way indicates whether a partial hit has been detected for a given way based on whether a match was detected between the preamble portion of the lookup tag and the preamble tag portion read out from the preamble tag RAM 54 for the given way. In some examples, the valid indicator may also be considered when generating the partial hit signal, so that a partial hit is indicated for a valid cache entry that has the matching preamble tag, and a miss is indicated for either (i) a way with a mismatching preamble tag, or (ii) a way that is indicated as invalid by the valid indicator (even if the stored preamble tag for that way did match the lookup tag computed from the target address).

The second stage tag lookup circuitry 56 receives the partial hit signals from the first stage tag lookup circuitry 52, indicating for each way whether a partial hit was detected based on the valid indicator and preamble tag comparison. If the partial hit signals indicate that all ways missed in the first stage tag lookup, there is no need to perform any lookup of the prologue RAM arrays 58 at all, and the energy cost of the second stage tag lookup can be avoided entirely. If at least one way of the selected set was detected as having a partial hit in the first stage lookup, then the corresponding prologue RAM array 58 is looked up by providing the set index and way identifier indicating the way with the partial hit. The prologue RAM array 58 returns the prologue tag portion and cached data for the identified way. Any prologue RAM arrays 58 for which none of the corresponding ways encountered a partial hit at the first tag comparison stage can be omitted from being looked up, to save power. Also, the output pins on the interface between the prologue tag RAMs 58 and the second stage tag lookup circuitry 56 which correspond to ways which encountered a miss in the first stage tag lookup can be suppressed from toggling, to further save power, so that only the pins which correspond to partial hitting ways toggle state when returning the prologue tag portion and cached data from the prologue RAM 58.

When there is at least one partial hitting way detected from the first stage tag lookup, the second stage tag lookup 56 compares, for each partial hitting way, the prologue tag portion returned for that way from the prologue RAM arrays 58 against the prologue portion of the lookup tag derived from the target address. If matching prologues are detected for one of the partial hitting ways, then a cache hit is detected, and the corresponding cached data is returned to the circuit component that requested the cached data. If none of the prologue comparisons for partial hitting ways detect a match, then a cache miss is detected, and this is signalled to a downstream component which can take a corresponding miss response (such as, for a read operation attempting to read cached data from the cache, fetching the required information for the read target address from a further cache or memory 10, or taking a default approach such as snooping all requester's caches 16 in the case of the snoop filter 20, and for a write operation attempting to write cached data to the cache, selecting an entry to be allocated with the cached data for the write target address).

By splitting the tag comparison into multiple stages, and halting lookups in the second stage for those prologue RAMs 58 which do not correspond to any partial hitting way detected in the first stage, this can save a significant amount of power compared to conventional cache implementations which compare the entire tag in a single stage, as the number of comparator gates which toggle state during the comparisons can be reduced.

In this example, the preamble tag portion comprises the lower bits of the lookup/cache tag and the prologue tag portion comprises the upper bits, but other examples could assign the preamble/prologue tag portions in other ways. It can be useful (for greater power savings) if the portion of bits assigned to the preamble tag portion is the portion likely to have greatest entropy among a set of addresses likely to be allocated to a given cache set at a given time (that is, it is more likely that this set of addresses will have different values for the preamble tag portion). In implementations where the tag is simply extracted from the target address without hashing, this is likely to be the least significant portion of the tag, but in other implementations which apply a hash function to the target address to obtain the tag, the portion with greatest entropy might not necessarily be the least significant portion. In any case, even if a portion of lower entropy is selected as the preamble, this can still offer power savings compared to an approach which compares the entire tag in a single tag lookup stage.

While FIG. 3A shows an example with a two-stage comparison, in other examples there could be more than two tag comparison stages. For example, the preamble tag could be further sub-divided into first and second preamble portions compared in successive stages of tag comparison, with a later preamble comparison stage suppressed for a way already detected in the earlier preamble comparison stage as missing against the target address being looked up. Hence, references to first and second tag lookup stages may correspond to any two of a set of two, three or more tag lookup stages.

FIG. 4 shows in more detail an implementation of the preamble tag RAM 54 used to provide the preamble tag portions for the first tag comparison stage 52. The preamble tag RAM 54 includes a bitcell array 60 comprising an array of bitcells implemented as a two-dimensional matrix arranged in rows and columns. Each bitcell of the bitcell array 60 stores a single bit of stored state, according to a memory storage technology such as static random access memory (SRAM). The preamble tag RAM 54 also includes:
control circuitry 62 for controlling the other components of the preamble tag RAM 54;
a row decoder 64 for decoding which row of bitcells is to be read/written in a read/write operation;
a wordline driver 66 for driving a wordline corresponding to the selected row of bitcells selected by the row decoder 64;
a read/write driver 68 comprising bitline drivers for driving bitlines for respective columns of the array with values corresponding to write data to be written to the active row during a write operation, and sense amplifiers for reading out the values on the bitlines corresponding to the read data read from the active row during a read operation;
ECC computation/checking circuitry 70 for computing an ECC for the selected row on a write operation, and performing ECC checking to generate an error syndrome value based on the stored ECC and other contents of the row on a read operation.
input/output (I/O) buffers 72 which receive write data from a write requesting circuit component for a write operation and supply the write data to the write driver 68, and which output the read data received from the read/write driver 68 for a read operation to a downstream circuit component, such as the first stage tag lookup circuitry 52.

For both a write operation and a read operation, the control circuitry 62 receives the set index identifying the selected set of cache entries, which is decoded into row selection control bits by the row decoder 64 (those row selection control bits being set to an inactive state for all rows other than a selected row corresponding to the set index and to an active state for the selected row). The row selection control bits control the wordline driver 66 to assert the wordline corresponding to the selected row. Other wordlines are deasserted. This causes the bitlines in respective columns of the bitcell array 60 to be coupled to the bitcells in the selected row.

For a write operation, where the preamble tag and/or valid bit of at least one way needs to be updated (e.g. on invalidation or re-allocation of an entry in the selected set), the write data providing the updated information for the selected row is received at the I/O buffers 72, or if that write data does not contain updated values for the entire row, there may be an additional read cycle performed before the write to obtain the valid/preamble values for other ways in the same row that are not being updated, before continuing with the write. The ECC computation circuitry 70 computes an ECC based on the updated values of the valid indicators/preamble tags for the entire row. The write drivers 68 control each pair of bitlines for the columns within the row to be driven to a state depending on the value of a corresponding bit of the updated write data for the row (e.g. bitlines set to complementary values (0, 1) or (1, 0) for logical 0 and 1 respectively, or vice versa). This causes the bitcells in the selected row to update their state to match the write data including the valid indicators, preamble tags and ECC.

On the other hand, for a read operation, having driven the selected wordline for the selected row using the wordline driver 66, the sense amplifiers in the read/write drivers 68 read out the values from the bitlines corresponding to cells in respective columns of the selected row, and capture from each column whether the read out state is logic 0 or logic 1 based on the state of the bitlines. The read out bit values (including the valid/preamble pairs for each way and the ECC for the row) are provided to the ECC checking circuitry 70 which computes an error syndrome value from the valid/preamble and the ECC. The error syndrome value is indicative of whether any error has arisen causing a flip of state for one or more of the bitcells of the row since that bitcell was previously written (e.g. for some ECC schemes the syndrome value may be expected to be 0 if there is no error, and non-zero if an error has occurred). The error syndrome value can be output to external error handling circuitry, which can use the syndrome value to detect whether an error has occurred and trigger an error handling response (e.g. reporting and/or correction of the error) if an error is detected. The I/O buffers 72 drive output pins with the read out information from the selected row, e.g. providing the valid indicator and preamble for each way to the first stage tag lookup circuitry 52 for performing the partial hit detection in the first stage tag lookup based on the preamble tag comparisons.

FIG. 5 shows an example of a given prologue RAM array 58 from the example of FIG. 3A. Similar to the preamble RAM array 54 shown in FIG. 4, the prologue RAM array 58 includes a bitcell array 60, control circuitry 62, a row decoder 64, wordline driver 66, read/write driver 68, ECC computation/checking circuitry 70 and I/O buffers 72. The sense amplifiers of the read/write driver 68 in the prologue RAM array 58 can be an example of the bitcell readout circuitry mentioned earlier.

However, the prologue RAM array 58 also includes isolation gates 74 on the path between the ECC checking circuitry 70 and I/O buffers 72 which isolate the I/O buffers 72 from the prologue/data bits read out by the read/write driver 68 for inactive ways (which are not needed for the prologue lookup because they encountered a miss in the first tag comparison stage 52), to prevent the output pins of the I/O buffers 72 that correspond to the cached data for inactive ways from toggling in a read operation. The isolation gates 74 help save power because, in this implementation, the ECC in a given row of the prologue tag array 58 is shared between a way group comprising at least two ways (in this example of FIG. 5, the way group comprises two ways), even though for the prologue/cache data RAM 58 there are times when a way-specific read targeting only one of those ways may be desired and the cached prologue/data for other ways in the same way group is not needed to be output via I/O buffers 72 to the downstream logic such as the second stage tag lookup circuitry 56.

Hence, the contents of a given row of the prologue RAM array 58 provide the prologue tag portions and cached data (e.g. snoop filter information) for each way in the way group of two or more ways of a cache set, as well as a way-group-shared ECC shared between the ways of that way group. On a write operation, the way-group-shared ECC is computed from bits of the cached prologue/data of each way in the way group, and on a read operation, the way-group-shared ECC is used to compute a syndrome value from the way-group-shared ECC and the read out values of the prologue/data of each way in the way group. It may seem counter-intuitive to share the ECC between the prologue/data in multiple ways when there are scenarios when it is unnecessary to read out the data from each way as mentioned above (e.g. when the partial hit signals from the first stage tag lookup 52 indicates one way in the way group has a partial hit and another way in the way group has a miss, and so only the prologue tag and cached data for the partial hitting way is needed for the second stage tag lookup 56).

However, the inventors recognised that typical ECC schemes require a certain number of ECC check bits to protect a data word having a given number of data bits. The number of ECC check bits scales more slowly with the data word size than the data word size itself. For example, for one ECC scheme, providing the required level of error protection may require a number of ECC check bits selected based on the corresponding data word size as follows:

| data word size | ECC check bits |
|---|---|
| 1-8 | 4 |
| 9-16 | 5 |
| 17-32 | 6 |
| 33-64 | 7 |
| 65-128 | 8 |
| 129-256 | 9 |

Hence, for each doubling of the number of data word bits, only one additional ECC check bit is required. It will be appreciated that the precise number of ECC check bits shown here for a given number of data word bits may depend on the particular ECC scheme used, and other ECC schemes may have a different absolute number of ECC check bits for a given data word size, but nevertheless shows a similar trend where the ECC check bit size scales more slowly than the data word size.

This means that, in general, the number of ECC check bits required to protect a given number of ways as a whole can be greatly reduced by sharing the same ECC between multiple ways. For example, if each way comprises a 36-bit data word, with an ECC per way this means a group of 2 ways comprises 2*7=14 ECC bits for every 2*36=72 bits of data. In contrast, if the 2 ways share the same ECC then the same 72 bits of data may be protected using only 8 bits of ECC, providing a saving of 3 bits per way, i.e. a total saving across the array of 3*S*W bitcells where S is the number of sets and W is the associativity (number of ways per set). This can provide a significant power saving across the prologue RAM array 58 by reducing the static/dynamic power consumption consumed by not only the bitcells themselves, but also the associated control logic such as the write drivers and sense amplifiers in the read/write driver 68.

The number of stored ECC bits could be reduced further by grouping more than two ways together in the same way group (e.g. a way group of 4 ways with 36-bit data words sharing the same ECC would then mean 1 ECC of 9 bits per 4*36=144 bits of data, rather than 16 bits of ECC per pair of way groups each having 2 ways). However, the power savings from the ECC bitcell reduction are to be traded off against the associated power cost of reading out a greater number of unneeded ways of preamble/data for other ways in the same way group when only one way's preamble/data is needed, as the sharing of ECCs means that the data from each of the grouped ways is needed when computing the ECC and calculating the error syndrome value, even if other ways in the same way group as a way of interest are not needed to be read/written. Hence, in some examples, a grouping of 2 ways per way group may provide the preferred balance between read out cost and ECC bitcell saving. Hence, in the example of FIG. 5, 2 ways per way group are provided, and the prologue RAM array 58 shown in FIG. 5 shows the prologue/data for ways 0 and 1 of a given cache set (with other similar arrays being shown for other way groups corresponding to way pairs 2 and 3; 4 and 5; etc., with the total number of way groups depending on associativity of the cache). Nevertheless, other examples may find that a way group size of 4 ways or more may provide the preferred trade-off point.

Therefore, on a write operation to the prologue RAM 58, a write data word comprising updated prologue/data for the whole way group is used to compute the way-group-shared ECC for that way group. That write data word could be received at the I/O buffers 72 in its entirety from an external component, or could be assembled from new write data received at the I/O buffers 72 for one or more ways and previously stored data read out from the bitcell array 60 for other ways in the same way group for which no change to the stored data is needed. FIG. 6 illustrates an example of computation of the way-group-shared ECC from the data word comprising the prologue tag bits and data bits from each way in the group. The ECC computation circuitry 70 comprises a network of XOR (exclusive OR) gates 76. The ECC is generated with X code bits, where X is a given integer, e.g. selected based on data word size for the overall contents of the way group comprising multiple ways according to the table described earlier (e.g. with a way group of two ways with each way having K bits of state across the preamble, data and any other contents of the cache entry to be protected (other than the ECC itself), the overall data word size for the way-group-shared way group would be 2K bits). Each code bit of the way-group-shared ECC is computed as the XOR of a corresponding subset of bits from the associated way group's data word, and for at least one code bit of the ECC, the corresponding subset of bits used to compute a given code bit includes bits extracted from more than one way. Each code bit corresponds to a different subset of bits selected from the way group's data word. Some bits of the way group's data word can contribute to more than one code bit. Any known ECC scheme may be used to determine the patterns of bit combinations used to calculate each code bit, but in comparison to ECC schemes used in other caches, the ECC computation is applied to a larger data word of granularity corresponding to a group of multiple cache ways, rather than a single cache way.

Similarly, on a read operation to the prologue RAM 58, a data word covering the prologue tags and data for multiple cache ways, and the associated X-bit way-group-shared ECC, are read out from the bitcell array 60 and (as shown in FIG. 7) are used by the ECC checking circuitry 70 to compute an X-bit syndrome value which indicates whether or not the ECC corresponds to the associated data word. Each syndrome bit corresponds to a given one of the code bits of the ECC and is computed by corresponding portion of an XOR network 78 as the XOR of that code bit with the bits at the same positions within the multi-way data word that were used to compute that associated code bit when the ECC was calculated on a previous write as discussed for FIG. 6. Since the XOR gates 78 of the ECC checking circuitry 70 on a read essentially reverse the combinations of bits made in computing the code bits using the ECC computation circuitry 70 on a write, then if there has been no error and the stored data word is still the same as when the data word/ECC pair was written to the prologue RAM 58, the syndrome value should have all bits equal to 0. If at least one syndrome bit is 1, an error is indicated.

In the example of FIG. 5, the ECC checking circuitry 70 integrated into the prologue RAM 58 includes the syndrome calculation circuitry 78, but does not include circuitry for implementing other parts of ECC checking operations for interpreting the syndrome to detect whether an error has occurred, detect whether the error is correctable, and if correctable, identify the locations of the erroneous bits and the updates to stored bits needed to correct those erroneous bits. In this case, the ECC checking circuitry 70 may simply compute the error syndrome value and then output it to external ECC error handling circuitry to perform other parts of ECC error processing. The output of the prologue tags and data from the read out ways may still take place via the isolation gates 74 and I/O buffers 72 regardless of whether the error syndrome value indicates any error has occurred (with the isolation gates 74 suppressing toggling of I/O buffer output pins that correspond to inactive ways for which a partial way miss was detected in the first stage tag lookup 52).

In other examples, the ECC checking circuitry 70 could also act as error handling circuitry which not only computes the error syndrome value, but also detects/corrects errors and handles any reporting of errors to external components (if required). For example, if the ECC is implemented according to a SECDED (single error correction, double error detection) scheme, the combinations of data word bits used to compute each ECC code bit or syndrome bit may be selected so that, for any given single bit error, this will correspond to a unique encoding of the syndrome value, which can be decoded to identify the location of the erroneous bit (which could be either in the data word or in one of the ECC code bits) that needs to flip state to correct the error. On the other hand, if errors affect more than one bit in the same data word, such double errors may correspond to other syndrome values, which can be decoded to identify that the error is not correctable.

If the error is correctable, the corrected value of the erroneous bit may be substituted for the erroneous value before outputting the corrected data to the I/O buffers 72, and also the corrected value of the erroneous bit may be written back to the affected bitcell in the bitcell array 60, to ensure the error is corrected both for the current read and for later reads of the same data. In some examples, even if the error is correctable, the occurrence of the error may still be reported to an external components, as error rate may be of interest to detect risk of physical attack on the system or age-related deterioration of hardware components.

On the other hand, if the error cannot be corrected, the uncorrectable error may be signalled to an external component, which may take an error handling response such as triggering the same response that is taken on a cache miss (e.g. broadcasting snoops to all requester caches in the case of a snoop filter 20, requesting a linefill of data from a further cache or memory in the case of a load/store data cache 16, 18, performing a page table walk operation for a TLB, or predicting a default branch prediction of not-taken for a branch prediction cache), and/or reporting the uncorrectable error (e.g. signalling a fault, or even if not faulting, logging the uncorrectable error in an error log).

FIG. 8 illustrates a method for accessing a cache. At step 100, bitcell readout circuitry 68 reads a selected row of bitcells of the data bitcell array 58 of a cache 20, to obtain cached data for a way group comprising two or more cache ways and a way-group-shared ECC shared between the ways of the way group. At step 102, the ECC checking circuitry 70 determines an error syndrome value using the way-group-shared ECC and the cached data read out for the way group. At step 104, output circuitry 72 outputs to a downstream circuit component the cached data read out for at least one way of the way group (not necessarily all ways, as the isolation gates 74 may suppress output of unneeded ways whose data was only read out to support the computation of the error syndrome value shared across ways).

FIG. 9 illustrates a method for looking up a cache in a specific example using separate preamble/prologue tag lookup stages as described for FIGS. 3A to 7 discussed above. At step 120, the set index/tag computation circuitry 40 generates the set index and lookup tag based on a target address being looked up in the cache. At step 122, the first stage tag lookup circuitry 52 accesses the preamble tag RAM 54 to read out preamble tag portions for each way of a selected set corresponding to the set index, and performs a first tag comparison stage comparing a preamble portion of the lookup tag against the preamble tag portions of each way, to detect a partial hit/miss signal for each way. At step 124, the second stage tag lookup circuitry 56 performs a prologue tag lookup for each partial-hitting way for which a partial hit is detected in the first tag comparison stage, to read out from the prologue RAMs 58 prologue tag portions and cached data for each partial-hitting way (note that step 124 can be omitted altogether if there are no partial-hitting ways detected at step 122). At step 126, the second stage tag lookup circuitry 56 compares the prologue tag portions for each partial-hitting way with the prologue portion of the lookup tag, to detect whether any way has a full hit on both preamble and prologue tag portions, and generates an overall hit/miss response for the cache based on whether any full hit has been detected. If a hit is detected, the cached data is returned for the hitting way. In some examples, an early miss signal indicating whether there is a miss in the cache can also be generated at the first tag comparison stage 52. The early miss signal may be generated specifying that the lookup missed, if the partial hit signals for each way all indicate a miss. If any of the partial hit signals indicates a partial hit, then the early miss signal does not indicate a miss, and whether the hit/miss signal at the second tag comparison stage 56 indicates a hit or miss will depend on the outcome of the lookup and tag comparison based on the prologue RAM 58 accessed for any partial hitting ways.

FIG. 10 shows more detail for step 124 of FIG. 9, for looking up a given prologue RAM 58. Note that the steps of FIG. 10 may be performed separately for each prologue RAM that contains at least one partial hitting way. Prologue RAMs that do not correspond to any partial hitting way can have their lookup omitted to save power. At step 150 of FIG. 10, the control circuitry 62 of the prologue RAM 58 controls the row decoder 64 two decodes the set index to select a particular row of bitcells, and the word line driver 66 asserts the wordline for the selected row and deasserts wordlines for other rows. At step 152, the control circuitry 62 controls the bitcell readout circuitry (e.g. sense amplifiers) 68 to read out prologue tag portions, cached data (e.g. snoop filter information) and the way-group-shared ECC for a selected way group from the selected row of bitcells activated by the word line driver at step 150. At step 154, the ECC checking circuitry 70 computes the error syndrome value based on the way-group-shared ECC and the prologue tags/cached data for the group of ways read out from the selected row of bitcells. In some examples, further ECC checking operations based on the error syndrome value may also be performed at step 154, to detect/correct errors and report errors if necessary, but other examples may limit step 154 to computing the error syndrome value and outputting the syndrome value to an external error handling circuit (outside the prologue array 58) which will perform other parts of the error checking/correction operation). At step 158, the control circuitry 62 controls the isolation circuitry 74 to close the isolation gates 74 corresponding to ways for which a miss was detected in the first tag lookup stage based on the preamble tag comparison. This prevents toggling of prologue tag or cached data output pins of the I/O circuitry 74 that correspond to ways in the way group that are not partial-hitting ways detecting as having a partial hit in the first tag lookup stage. At step 160, the control circuitry 62 controls the I/O circuitry 74 to output the prologue tag portion cached data for any partial-hitting ways (with the I/O pins for other non-partial-hitting ways being prevented from toggling due to the isolation applied at step 158, to save power).

FIG. 11 illustrates steps for performing a write operation to the cache. At step 180, a write request indicating that a write operation is required which writes updated cached data to the cache for a selected way of a given cache set. At step 182, cached data for at least one other way in the same way group as the selected way is read from the bitcell array by the bitcell readout circuitry 68 from the row of bitcells corresponding to the given cache set. At step 184, an updated way-group-shared ECC for the way group is computed based on the updated cached data for the selected way received with the write request at step 180 and the read out cached data for the at least one other way. At step 186, the updated cached data and the way-group-shared ECC computed at step 184 is written to the bitcells of the row corresponding to the given cache set.

While several examples discussed above apply the way-group-shared ECC concept to the prologue RAM 58, the same technique could also be used in other cache RAMs for which the granularity of data access (the granularity with which data from a given row of the cache RAM is to be requested by a requesting circuit component) is smaller than the granularity of error protection (the granularity of the data word protected against errors by a single shared ECC). For example, while in the above example of FIG. 4, the preamble RAM 54 has the error protection granularity equal to the data access granularity (the ECC is shared between N ways and the first stage tag lookup circuitry 52 requests access to the preamble tags for N ways at a time), in other examples, multiple groups of N ways (e.g. 2N ways) could be grouped into a single row of a preamble tag RAM 54 sharing the same ECC so that the ECC granularity of 2N ways is more coarse-grained than the data access granularity of N ways.

Similarly, it is not essential for the cache RAM that contains the way-group-shared ECC to also contain prologue tag bits. In other examples, all tag bits could be in a tag RAM checked in a single stage of tag comparison, and then the subsequent cached data access may be in a separate cached data RAM which uses way-group-shared ECCs to reduce the ECC cost for a given data word size. Again, such a cached data RAM (not containing any tag information) may have a data access granularity (per-way) that is finer-grained than the ECC protection granularity (way groups of two or more ways).

Hence, it will be appreciated that the way group based ECC concept can be applied in other scenarios than those discussed as examples above.

Concepts described herein may be embodied in a system comprising at least one packaged chip. The cache described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

As shown in FIG. 12, one or more packaged chips 400, with the cache described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the cache described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A cache comprising:
a data bitcell array comprising a plurality of rows of bitcells;
bitcell readout circuitry configured to read a selected row of bitcells of the data bitcell array, to obtain:
cached data for a way group comprising at least two ways of a selected cache set of the cache, and
a way-group-shared error correcting code (ECC), shared between the at least two ways of the way group, for error-protecting the cached data for the at least two ways;
ECC checking circuitry configured to determine, based on the way-group-shared ECC and the cached data for the way group, an error syndrome value indicative of whether the way-group-shared ECC corresponds to the cached data for the way group; and
output circuitry configured to output, to a downstream circuit component, the cached data read from the selected row of bitcells for at least one way of the way group.

2. The cache according to claim 1, in which, in response to a way-specific read operation requesting the cached data for a specified way of the selected cache set, the bitcell readout circuitry is configured to read out the cached data for the way group including cached data for at least one other way for which the cached data is not required for servicing the way-specific read operation, to allow the ECC checking circuitry to determine the error syndrome value using the cached data for each of the at least two ways that share the way-group-shared ECC.

3. The cache according to claim 2, in response to the way-specific read operation, the output circuitry is configured to prevent toggling of output pins corresponding to the cached data for the at least one other way.

4. The cache according to claim 1, comprising ECC computation circuitry configured to compute the way-group-shared ECC depending on the cached data for the at least two ways.

5. The cache according to claim 4, comprising control circuitry configured to control, in response to a write operation to provide updated cached data for a selected way:
the bitcell readout circuitry to read out the cached data for at least one other way in a same way group as the selected way, and
the ECC computation circuitry to compute the way-group-shared ECC depending on the updated cached data for the selected way and the cached data read out for the at least one other way.

6. The cache according to claim 1, in which the cache is an N-way set-associative cache, and the data bitcell array is configured to store cached data for M ways of the cache, where M<N.

7. The cache according to claim 6, comprising a plurality of said data bitcell arrays, each configured to store cached data for a respective group of M ways of the N-way set-associative cache.

8. The cache according to claim 1, in which the way group sharing the way-group-shared ECC is a group of 2 ways.

9. The cache according to claim 1, in which the data bitcell array is separate from a tag bitcell array configured to store at least a portion of cache tags for respective ways of the cache.

10. The cache according to claim 1, in which the bitcell readout circuitry is configured to also read out prologue tag portions for the way group from the selected row of bitcells of the data bitcell array.

11. The cache according to claim 10, in which the way-group-shared ECC protects both the prologue tag portions and the cached data of the at least two ways of the way group.

12. The cache according to claim 10, comprising tag lookup circuitry configured to:
perform a first tag comparison stage to perform tag comparisons between a preamble tag portion of a lookup tag computed from a target address being looked up in the cache and preamble tag portions read from a preamble tag bitcell array, separate from the data bitcell array, for a plurality of ways of the selected cache set; and
dependent on detecting a partial hit in the first tag comparison stage for at least one partial-hitting way of the plurality of ways, perform a subsequent tag comparison stage between a prologue tag portion of the lookup tag and the prologue tag portion read from the data bitcell array for the at least one partial-hitting way.

13. The cache according to claim 12, in which, when the at least one partial-hitting way is in a way group shared with at least one other way for which a miss is detected in the first tag comparison stage:
the bitcell readout circuitry is configured to read out the cached data for the at least one other way to enable the ECC checking circuitry to determine the error syndrome value using the cached data for the at least one partial-hitting way and the at least one other way; and
the output circuitry is configured to prevent toggling of output pins for outputting the cached data for the at least one other way to the tag lookup circuitry.

14. The cache according to claim 1, comprising error handling circuitry configured to trigger an error handling response in response to determining, based on the error syndrome value determined by the ECC checking circuitry, that an ECC check error has occurred.

15. The cache according to claim 1, in which the cache is a snoop filter.

16. The cache according to claim 15, in which the cached data comprises snoop filter information indicative of which of a plurality of requester caches should be snooped in response to an event associated with an address of a given cache line.

17. A system comprising:
the cache of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. Computer-readable code for fabrication of a cache comprising:
a data bitcell array comprising a plurality of rows of bitcells;
bitcell readout circuitry configured to read a selected row of bitcells of the data bitcell array, to obtain:
cached data for a way group comprising at least two ways of a selected cache set of the cache, and
a way-group-shared error correcting code (ECC), shared between the at least two ways of the way group, for error-protecting the cached data for the at least two ways;
ECC checking circuitry configured to determine, based on the way-group-shared ECC and the cached data for the way group to determine, an error syndrome value indicative of whether the way-group-shared ECC corresponds to the cached data for the way group; and
output circuitry configured to output, to a downstream circuit component, the cached data read from the selected row of bitcells for at least one way of the way group.

20. A method comprising:
reading a selected row of bitcells of a data bitcell array of a cache, to obtain:
cached data for a way group comprising at least two ways of a selected cache set of a cache, and
a way-group-shared error correcting code (ECC), shared between the at least two ways of the way group, for error-protecting the cached data for the at least two ways;
determining, based on the way-group-shared ECC and the cached data for the way group, an error syndrome value indicative of whether the way-group-shared ECC corresponds to the cached data for the way group; and
outputting, to a downstream circuit component, the cached data read from the selected row of bitcells for at least one way of the way group.
